(19) United States
(12) Patent Application Publication
(10) Pub. No.: US 2006/0293486 A1
(43) Pub. Date: Dec. 28, 2006

(54) Polyurethane elastomers, a process for the preparation thereof and the use thereof

(76) Inventors: Eva Emmrich, Essen (DE); Klaus Brecht, Burscheid (DE); Frank Hahn, Dormagen (DE)

Correspondence Address: BAYER MATERIAL SCIENCE LLC, 100 BAYER ROAD, PITTSBURGH, PA, 15205, US

(21) Appl. No.: 11/454,469

(22) Filed: Jun. 16, 2006

(30) Foreign Application Priority Data
Jun. 22, 2005 (DE) 102005028785.9

(51) Int. Cl. C08G 18/00

(52) U.S. Cl. 528/44

(57) ABSTRACT

The invention relates to polyurethane elastomers, a process for the preparation of these polyurethane elastomers and a the preparation of elastomeric molded parts comprising these polyurethane elastomers. These elastomers comprise the reaction product of a polyol component, chain extenders and/or crosslinking agents, one or more amine catalysts, a catalyst mixture which contains at least one organic titanium compound and at least one organic zinc compound, and optionally an organic lithium carboxylate and/or an organic bismuth carboxylate; with a polyisocyanate component.

### CROSS REFERENCE TO RELATED PATENT APPLICATION

The present patent application claims the right of priority under 35 U.S.C. § 119 (a)-(d) of German Patent Application No. 10 2005 028 785.9, filed Jun. 22, 2005.

### BACKGROUND OF THE INVENTION

The present invention relates to polyurethane elastomers, a process for the preparation thereof, and to a process for preparing elastomeric molded parts comprising these polyurethane elastomers.

Polyurethane (PUR) elastomers have been known for a long time and have already been developed and tailor-made for a very wide range of different requirements as described in U.S. Pat. No. 5,952,053. A large number of different metal catalysts have already been tested and used to control the rate of polymerization. In addition to the widely used organotin compounds, the known catalysts also include organocompounds and organic salts of various other elements such as, for example, lithium, titanium, bismuth, zinc, zirconium. By way of example, catalyst mixtures of titanium, lithium and bismuth are described in U.S. Pat. No. 6,590,057. It is not possible, however, to achieve good flowability and simultaneously produce good mechanical properties in PUR systems when using this catalyst system.

An important area of application of PUR elastomers is, inter alia, the manufacture of soles for shoes. When producing these, the catalysts systems which are used must ensure good processability of the soles. More specifically, this includes short demolding times and high demolding hardness, as well as long cream time and good flowability in order to achieve contour-accurate filling of the mold. In addition, the catalysts must enable good final properties of the elastomers such as, for example, high tensile strengths, high extensions at break, and low hole-enlargement under long-term flexural strain. The known PUR elastomers that are prepared with conventional commercially available organotin catalysts only partly satisfy this list of requirements.

Thus, the object of the present invention was to provide PUR elastomers that, in addition to having good processing properties (e.g. long flow times, and short demolding times), also have good mechanical properties (e.g. good long-term properties, and high mechanical strengths), associated with improved gas yields.

Surprisingly, it has been found that PUR elastomers which are prepared from a special catalyst mixture as described herein, have the desired good processing properties, good mechanical properties and improved gas yields. The special catalyst mixture required by this invention, when compared to conventional commercially available organotin compounds, also achieves a much lower expanded foam bulk density and thus a lower molded part density.

### SUMMARY OF THE INVENTION

The invention relates to polyurethane elastomers and to a process for preparing these polyurethane elastomers. These polyurethane elastomers comprise the reaction product of:

(A) a polyol formulation comprising:

a) a polyol component comprising:
   a1) at least one polyetherpolyol having an OH number of 20 to 112 and a functionality of 2, and which is obtained by alkoxylation with propylene oxide and/or ethylene oxide such that the resultant polyetherpolyols contains mainly primary OH groups,
   and,
   a2) optionally, one or more polyetherpolyols having an OH value of 20 to 112 and a functionality of greater than 2 to 3.5, and which are obtained by alkoxylation with propylene oxide and/or ethylene oxide such that the polyetherpolyols contain mainly primary OH groups,
   and, in which a) the polyol component optionally contains a solids containing polyol which is selected from the group consisting of (i) graft copolymers of styrene and/or acrylonitrile, (ii) polyaddition polymers of diamines and diisocyanates and (iii) mixtures thereof;
b) one or more chain extenders and/or cross-linking agents having a molecular weight of 60 to 499 g/mol;
c) optionally, one or more blowing agents;
d) one or more amine catalysts;
e) a catalyst mixture comprising (1) at least one organic titanium compound, (2) at least one organic zinc compound, (3) optionally, one or more organic lithium carboxylates, and (4) optionally, one or more organic bismuth carboxylates;
   and
f) optionally, additives;
   with
   (B) a polyisocyanate component.

The reaction of (A) and (B) occurs while maintaining an equivalent ratio of NCO groups in (B) the polyisocyanate component to the sum of hydrogen atoms in components a), b), c), d) and e) that can react with isocyanate groups of 0.8:1 to 1.2:1, preferably of 0.95:1 to 1.15:1, and more preferably of 0.98:1 to 1.05:1.

The present invention also relates to a process for preparing these polyurethane elastomers. This process comprises reacting

(A) a polyol formulation (A) comprising

a) a polyol component comprising:
   a1) at least one polyetherpolyol having an OH number of 20 to 112 and a functionality of 2, and which is obtained by alkoxylation with propylene oxide and/or ethylene oxide such that the resultant polyetherpolyols contains mainly primary OH groups,
   and,
   a2) optionally, one or more polyetherpolyols having an OH value of 20 to 112 and a functionality of greater than 2 to 3.5, and which are obtained by alkoxylation with propylene oxide and/or ethylene oxide such that the polyetherpolyols contain mainly primary OH groups,
   and, in which a) the polyol component optionally contains a solids containing polyol which is selected from the group consisting of (i) graft copolymers of styrene and/or acrylonitrile, (ii) polyaddition polymers of diamines and diisocyanates and (iii) mixtures thereof;
b) one or more chain extenders and/or cross-linking agents having a molecular weight of 60 to 499 g/mol;
c) optionally, one or more blowing agents;
d) one or more amine catalysts;
e) a catalyst mixture comprising (1) at least one organic titanium compound, (2) at least one organic zinc compound, (3) optionally, one or more organic lithium carboxylates, and (4) optionally, one or more organic bismuth carboxylates;
and
f) optionally, additives;
   with
   (B) a polyisocyanate component;
   while maintaining an equivalent ratio of NCO groups in (B) the polyisocyanate component to the sum of hydrogen atoms in components a), b), c), d) and e) that can react with isocyanate groups of 0.8:1 to 1.2:1, preferably of 0.95:1 to 1.15:1, and more preferably of 0.98:1 to 1.05:1.

### DETAILED DESCRIPTION OF THE INVENTION

Suitable catalyst mixtures to be used as component e) in the present invention comprise (1) at least one organic titanium compound, (2) at least one organic zinc compound, (3) optionally, one or more organic lithium carboxylates, and (4) optionally, one or more organic bismuth carboxylates.

Suitable organic titanium compounds to be used as component (1) of e) the catalyst mixture include, preferably, compounds which correspond to the following formula:
[M(L¹)ₚ(L²)ₚ(L³)ₚ(L⁴)ₚ]ₙ (I)
wherein:
   M represents Ti⁴⁺;
   n represents a value of from 1 to 20,
   p represents a value of 0 to 4,
   and
   L¹, L², L³ and L⁴ each independently represent identical or different groups which are coordinate bonded via O, S or N atoms.

Some examples of suitable groups which are coordinate bonded via an oxygen atom, a sulfur atom, or a nitrogen atom and which L¹, L², L³ and L⁴ may represent include groups such as, for example.:
(1) alcoholates, phenolates, glycolates, thiolates, carboxylates or aminoalcoholates, each of which may contain from 1 to 20 carbon atoms, and which may, optionally, contain one or more functional groups (such as, for example, hydroxyl, amino, carbonyl etc.), or may, optionally, contain oxygen, sulfur or nitrogen groupings between the carbon atoms (such as, for example, ether, thioether, amine or carbonyl groups),
   and
(2) various fluorine-free, sterically unhindered chelate ligands including, for example, 1-diketones such as, for example, benzoylacetone, dibenzoylmethane, ethylbenzoylacetate, methylacetoacetate, ethylacetoacetate and 2,4-pentanedione (i.e. acetylacetone), and other chelate ligands including, for example, N,N-diethylethanolamine, triethanolamine, salicyl aldehyde, salicyl amide, phenyl salicylate, cyclopentanone-2-carboxylic acid, bisacetylacetylacetone, thioacetylacetone, and N,N′-bis(salicylidene)ethylenediamine.

Preferred organic titanium compounds include, for example, titanium(IV) isopropoxide, titanium(IV) n-butoxide, titanium(IV) 2-ethylhexoxide, titanium(IV) n-pentoxide, titanium(IV) (triethanolaminato)isopropoxide, titanium(IV) (trethanolaminato)-n-butoxide, isopropyl triisostearyl titanate, bis(8-quinolinolato)-titanium(IV) dibutoxide, bis(ethylacetoaceto) titanium(IV) diisobutoxide, etc.

It is more preferred that the titanium compounds include those with ligands from the second group, i.e. group (2), mentioned above. Such compounds include, for example, titanium(IV) bis(ethylacetoaceto) diisopropoxide, titanium(IV)-diisopropoxide-bis(2,4-pentanedionate), titanium(IV) triisopropoxide-(2,4-pentanedionate), ethoxybis(pentane-2,4-dionato-0,0′)(propan-2-olato)titanium, titanium(IV) oxide acetylacetonate, bis(diacetylacetonato) titanium(IV)-butoxide-isopropoxide, bis(diacetylacetonato)titanium(IV)-ethoxide-isopropoxide, etc.

Some examples of suitable compounds to be used as organic zinc compounds for component (2) of e) the catalyst mixture include, for example, saturated or unsaturated, aliphatic or alicyclic or aromatic carboxylates of zinc. These suitable zinc compounds typically correspond to the following formula:
[Zn(OOCR)₂]
wherein:
   R represents a hydrocarbon group having from 1 to 25 carbon atoms.

Preferred zinc compounds include, for example, zinc(II) acrylates such as zinc(II) methacrylate, zinc(II) acetate, zinc(II) citrate, zinc(II) salicylates such as zinc(II) 3,5-di-tert.-butylsalicylate, zinc(II) oxalate, zinc(II) adipate, zinc(II) carbamates such as zinc(II) dimethyldithiocarbamate, zinc(II) phthalocyanines such as zinc(II) octabutyloxyphthalocyanine, zinc(II) thiolates and zinc(II) stearate, etc. More preferred zinc compounds include, for example, zinc(II) naphthenate, zinc(II) decanoate, zinc(II) butyrate, such as zinc(II) 4-cyclohexyl-butyrate, zinc(II) neodecanoate, zinc(II) isobutyrate, zinc(II) benzoate, as well as zinc(II) bis-2,2,6,6-tetramethyl-3,5-heptanedionate and zinc(II) p-toluenesulfonate. Zinc(II) octoate and zinc(II) 2-ethylhexanoate are most preferred as component (2) of e) the catalyst mixture.

When e) the catalyst mixture additionally comprises (3) one or more organic bismuth carboxylates, these are are preferably saturated or unsaturated, aliphatic or alicyclic or aromatic bismuth carboxylates. The bismuth carboxylates preferably correspond to one of the following formulas:
[Bi(OOCR)₃]
wherein:
   R represents a hydrocarbon group having 1 to 25 carbon atoms;
      and
      [Bi₂((OOC)₂R′)₃]
wherein:
   R′ represents a hydrocarbon group having 1 to 25 carbon atoms.

The preferred bismuth carboxylates includee bismuth(III) versatate, bismuth(III) tallate, bismuth(III) stearate, bismuth(III) adipate and bismuth(III) oxalate. Bismuth(III) naphthenate, bismuth(III) decanoate, bismuth(III) butyrate, bismuth(III) isobutyrate, bismuth(III) nonate and bismuth(III) caprioate are preferred compounds to be used as component (3) of e) the catalyst mixture. Bismuth(III) neodecanoate, bismuth(III) 2-ethylhexanoate and bismuth(III) octanoate are particularly preferred as component (3) of e) the catalyst mixture.

When e) the catalyst mixture additionally comprises (4) one or more organic lithium carboxylates, suitable lithium carboxylates include those which may be used either as a solid or in solution.

Many of the compounds which are suitable as a component of e) the catalyst mixture may form agglomerates and/or higher molecular weight condensation products that contain two or more metal centers that are linked to each other via one or more bridging ligands.

Both d) the one or more amine catalysts, and e) the catalyst mixture may be used in the present invention as solids or in the form of solutions. Saturated or unsaturated, aliphatic or alicyclic or aromatic carboxylic acids of the general formulae
RCOOH
and
HOOC—R′—COOH
may be used in particular as solvents, wherein:
R and R′ each independently represent a hydrocarbon group with 1 to 25 carbon atoms.

Suitable examples of such solvents include compounds such as neodecanoic acid, 2-ethylhexanoic acid and naphthenic acid. These three compounds are preferred solvents.

In accordance with the present invention, the catalyst mixture e) is preferably used in an amount of from 0.001 to 10 wt. %, preferably from 0.01 to 1 wt. %, based on 100 wt. % of compounds a), b), c), d) and f).

Suitable catalysts to be used in accordance with the present invention as d) the amine catalysts include, preferably tertiary amines such as, for example, triethylamine, tributylamine, N,N,N′N′-tetramethylethylenediamine, pentamethyl-diethylene-triamine and higher homologues, 1,4-diaza-bicyclo-[2.2.2]-octane, N-methyl-N′-dimethylaminoethyl-piperazine, bis(dimethylaminoalkyl)-piperazine, N,N-dimethyl-benzylamine, N,N-dimethylcyclohexylamine, N,N-diethylbenzylamine, 1,2-dimethylimidazole, 2-methylimidazole, monocyclic and bicyclic amidines, bis(dialkylamino)alkyl ethers such as bis(dimethylaminoethyl)ether, as well as amide group-containing compounds.

In accordance with the present invention, a) the polyol component preferably has an average functionality of 2.0 to 3.0. In the broadest sense of the invention, the polyol component a) comprises:
a1) at least one polyetherpolyol having an OH number of 20 to 112 and a functionality of 2, which is obtained by alkoxylation of a suitable starter with propylene oxide and/or ethylene oxide such that the resultant polyetherpolyol contains mainly primary OH groups.

In addition, a) the polyol component may optionally comprise:
a2) one or more polyetherpolyols having an OH value of 20 to 112 and a functionality of greater than 2 to 3.5, which is obtained by alkoxylation of a suitable starter with propylene oxide and/or ethylene oxide such that the resultant polyetherpolyols contain mainly primary OH groups.

Finally, the polyol component a) may optionally contain the so-called organic polymeric fillers, or a polyol which contains finely dispersed solids. These polyols which contain solids are selected from the group consisting of (i) graft copolymers which may be obtained by grafting with styrene and/or acrylonitrile onto a base polyol (such base polyols include those polyols described as a1) and/or a2) above), or (ii) polyaddition polymers of diamines and diisocyanates in, e.g. polyols as solvent. A blend or a mixtures of (i) and (ii) may also be used.

In accordance with the present invention, suitable compounds to be used as (B) the polyisocyanate component herein include, preferably aromatic polyisocyanates, and more preferably diisocyanatodiphenylmethane (MDI). The isocyanates may be used, for example, in the form of pure compounds or as modified MDI compositions such as, for example, in the form of uretdiones, isocyanurates, biurets and allophanates, as well as prepolymers prepared therefrom with a NCO content of 10 to 28%. Suitable prepolymers to be used as (B) the polyisocyanate component may be prepared, for example, by the reaction of 1) a diisocyanatodiphenylmethane, with 2) one or more polyol components having an OH number of 20 to 112 and an average functionality of 2.0 to 3.0, and 3) one or more polyol components having a molecular weight of 135 to 700 g/mol. The isocyanate may also contain carbodiimide groups.

Preferred polyisocyanate components to be used as component (B) include a prepolymer that comprises the reaction product of:
1) 4,4′-diphenylmethane diisocyanate and/or 4,4′-diphenylmethane diisocyanate modified by carbodiimidisation
   with
2) one or more polyetherpolyols having an OH number of 20 to 112,
   and
3) one or more polyethylene glycols and/or polypropylene glycols having molecular weights of 135 g/mol to 700 g/mol.

In accordance with the present invention, component (b), i.e. the one or more chain extenders and/or crosslinking agents to be used as part of (A) the polyol formulation, include compounds, for example, difunctional or trifunctional alcohols with molecular weights in the range of 60 to 499. Some examples of such compounds include, for example, 1,2-ethandiol, propylene glycol, 1,4-butanediol, diethylene glycol, triethylene glycol, trimethylolpropane, glycerine, triethanolamine, as well as various aromatic and/or aliphatic diamines which are known can preferably be used as component b).

To produce microcellular PUR elastomers, component c) a blowing agent, is preferably present as part of (A) the polyol formulation. Water is a preferred blowing agent in this aspect of the invention. The blowing agent, preferably water, reacts with component (B) the polyisocyanate component in situ, with the formation of carbon dioxide and amino compounds that, for their part, then further react with additional isocyanate groups to give urea components, and thus act as chain extenders.

Other suitable blowing agents include physical blowing agents such as, for example, gases or very volatile inorganic or organic substances which have boiling points of −40° C. to +70° C. These gases and other physical blowing agents may be used either instead of water, or preferably, in combination with water, as component c) the blowing agent. Suitable blowing agents to be used also include, for example, halogen-substituted alkanes or perhaloganated alkanes such as R134a, R141b, R365mfc, R245fa, or hydrocarbons such as, for example, n-butane, isobutane, n-pentane, isopentane, cyclopentane, n-hexane, isohexane, cyclohexane, n-heptane, isoheptane or diethyl ether, etc. Also suitable to be used as blowing agents are air, CO₂ or N₂O. In addition, carbamates such as, for example, the adducts formed from ethylenediamine and CO₂, may be used as blowing agents.

The polyol formulation (A) may additionally comprise, optionally, f) one or more additives and/or auxiliary substances such as, for example, surface-active substances, foam stabilizers, cell regulators, internal blowing agents such as microspheres, internal mold release agents, colorants, pigments, fungistatic and/or bacteriostatic substances, light protective substances, antioxidants and antistatic agents, etc.

In order to prepare the polyurethane elastomers of the invention, the components are reacted in amounts such that the equivalent ratio of the NCO groups in (B) the polyisocyanate component to the sum of the hydrogen atoms in components a), b), c), d), e) and f), that can react with isocyanate groups is in the range of from 0.8:1 to 1.2:1, preferably 0.95:1 to 1.15:1 and more preferably 0.98:1 to 1.05:1.

To perform the process of the invention, the procedure is similar to that used in the process disclosed in the prior art. This means, in general terms, that components a), b), c), d) and e) are combined to form (A) a “polyol component”, which is reacted with (B) a polyisocyanate component in one step in a closed mold such as, for example, a closed metal or plastics mold, and in which conventional two-component mixing equipment is used. The amount of reaction mixture introduced into the mold and also the amount of blowing agent, in particular when water is the blowing agent, are calculated such that the process forms structural foams with a bulk density of 100 to 1050 kg/m³, preferably 250 to 950 kg/m³. The resultant products of the invention are preferably semi-rigid structural foams with compact surfaces. More specifically, these semi-rigid structural foams have a Shore A hardness is the range of 15 to 85, as determined in accordance with DIN 53 505.

An important area of use for these PUR elastomers of the present invention is the production of shoes, and particularly, for example, the production of expanded shoe soles or shoe inserts.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

PUR elastomers were prepared by mixing the A-component at 30° C. with the B-component (i.e. a prepolymer) in a low pressure foam unit, filling an aluminium hinged mold (size 200×70×10 mm) that was preheated to 50° C. with the mixture, closing the hinged mold and demolding the elastomer after about 4 minutes.

In accordance with the present invention, e)(1) at least one organic carboxylate of titanium, and e)(2) at least one organic compound of zinc, were combined with d) at least one tertiary amine catalyst, and used as the catalyst system in the polyol component, i.e. component A). The catalysts were added to the polyol formulation in the appropriate ratio as described in the following examples.

The Shore A hardness in accordance with DIN 53505 of the resultant elastomer prepared in the manner previously described was determined directly after demolding, and after storing for 24 hours. Furthermore, hole-enlargement in accordance with DIN 53522 was determined on a 2 mm wide cut made on the flexing line of the test specimen (dimensions 2 cm×15 cm×1 cm) after 60,000 flexing cycles. These results are summarised in Table 1 below.

Starting Materials:

The following starting components were used in the examples:

Polyetherpolyols:

1) a polyetherpolyol with an OH number of 28, and prepared by alkoxylating 70% propylene oxide and 30% ethylene oxide with propylene glycol as the stareter, such that the resultant polyetherpolyol contained mainly primary OH groups.
2) a SAN graft polyetherpolyol in which the base polyol had an OH number of 23 and glycerine was the starter compound.
3) a mixture of (i) tripropylene glycol and (ii) a polyetherpolyol based on propylene oxide, with the mixture of (i) and (ii) having an average OH number of 173.
   Polyisocyanate Component:
   1) a prepolymer having a NCO group content of 19.8% by weight, and prepared by reacting 66 parts by wt. of 4,4′-diisocyanatodiphenylmethane (4,4′-MDI), 5 parts by wt. of modified 4,4′-MDI which had a NCO content of 30% by wt. (prepared by partial carbodiimidization), and 29 parts by wt. of polyetherpolyol 3)
DABCO: diazabicyclooctane
Silicon DC 190: a polysiloxane foam stabiliser commercially available from Air products

### Example 1 (Comparison)

The polyol component (A) comprised:
1887.50 parts by wt. of the difunctional polyetherpolyol 1),
250.00 parts by wt. of polyetherpolyol 2),
250.00 parts by wt. of 1,4-butanediol,
1.00 parts by wt. of bismuth(III) neodecanoate,
2.00 parts by wt. of lithium 2-ethylhexanoate in 2-(2-ethoxyethoxy)ethanol,
2.00 parts by wt. of bis(diacetylacetonato)titanium(IV)-ethoxide-isopropoxide,
25.00 parts by wt. of DABCO,
20.00 parts by wt. of DABCO blocked with 2-ethylhexanoic acid,
5.00 parts by wt. of foam stabiliser Silicon DC 190,
7.50 parts by wt. of water
   100 parts by wt. of this polyol component were mixed with 70 parts by wt. of prepolymer 1).

### Example 2 (According to the Invention)

The polyol component comprised:
1875.00 parts by wt. of the difunctional polyetherpolyol 1),
250.00 parts by wt. of polyetherpolyol 2),
250.00 parts by wt. of 1,4-butanediol,
0.375 parts by wt. of bis(diacetylacetonato)titanium(IV)-ethoxide-isopropoxide,
17.50 parts by wt. of zinc(II) octoate
25.00 parts by wt. of DABCO,
20.00 parts by wt. of DABCO blocked with 2-ethylhexanoic acid,
5.00 parts by wt. of foam stabiliser Silicon DC 190,
7.50 parts by wt. of water
   100 parts by wt. of this polyol component were mixed with 70 parts by wt. of prepolymer 1).

### Example 3 (According to the Invention)

The polyol component comprised:
1888.50 parts by wt. of the difunctional polyetherpolyol 1),
250.00 parts by wt. of polyetherpolyol 2),
250.00 parts by wt. of 1,4-butanediol,
0.375 parts by wt. of bis(diacetylacetonato)titanium(IV)-ethoxide-isopropoxide,
5.00 parts by wt. of zinc(II) octoate
25.00 parts by wt. of DABCO.
20.00 parts by wt. of DABCO blocked with 2-ethylhexanoic acid,
5.00 parts by wt. of foam stabiliser Silicon DC 190,
7.50 parts by wt. of water
   100 parts by wt. of this polyol component were mixed with 70 parts by wt. of prepolymer 1).

### Example 4 (According to the Invention)

The polyol component comprised:
1888.50 parts by wt. of the difunctional polyetherpolyol 1),
250.00 parts by wt. of polyetherpolyol 2),
250.00 parts by wt. of 1,4-butanediol,
0.375 parts by wt. of bis(diacetylacetonato)titanium(IV)-ethoxide-isopropoxide,
7.50 parts by wt. of zinc(II) octoate
5.00 parts by wt. of DABCO,
20.00 parts by wt. of DABCO blocked with 2-ethylhexanoic acid,
5.00 parts by wt. of foam stabiliser Silicon DC 190,
5.00 parts by wt. of water
   100 parts by wt. of this polyol component were mixed with 68 parts by wt. of prepolymer 1).

### Example 5 (According to the Invention)

The polyol component comprised:
1867.00 parts by wt. of the difunctional polyetherpolyol 1),
250.00 parts by wt. of polyetherpolyol 2),
250.00 parts by wt. of 1,4-butanediol,
0.375 parts by wt. of bis(diacetylacetonato)titanium(IV)-ethoxide-isopropoxide,
25.00 parts by wt. of zinc(II) octoate
25.00 parts by wt. of DABCO,
20.00 parts by wt. of DABCO blocked with 2-ethylhexanoic acid,
5.00 parts by wt. of foam stabiliser Silicon DC 190,
7.50 parts by wt. of water

100 parts by wt. of this polyol component were mixed with 70 parts by wt. of prepolymer 1).

TABLE 1

| | Example | | | | |
|---|---|---|---|---|---|
| | 1(C) | 2 | 3 | 4 | 5 |
| Cream time [s] | 10 | 10 | 10 | 10 | 10 |
| Tack free time [s] | 22 | 44 | 43 | 42 | 40 |
| Rise time [s] | 45 | 42 | 43 | 40 | 42 |
| Expanded foam bulk | 351 | 282 | 283 | 383 | 283 |
| density [kg/m³] | | | | | |
| Minimum demolding time | 5.0 | 3.5 | 3.5 | 3.5 | 2.5 |
| [min]* | | | | | |
| Shore A hardness, 1 min | 42 | 44 | 35 | 38 | 41 |
| after demolding | | | | | |
| Shore A hardness, 2 min | 44 | 46 | 40 | 41 | 43 |
| after demolding | | | | | |
| Shore A hardness, 10 min | 52 | 51 | 49 | 50 | 49 |
| after demolding | | | | | |
| Shore A hardness, 60 min | 55 | 54 | 52 | 54 | 52 |
| after demolding | | | | | |
| Shore A hardness, 24 h | 59 | 57 | 55 | 58 | 54 |
| after demolding | | | | | |
| Hole-enlargement after | Fractured after | 1.7 | 5.0 | 6.0 | 0.2 |
| 60000 bends [mm] | 45000 bends | | | | |

*Minimum demolding time means the time required for the production of a molded part that exhibits no cracks after demolding and folding through 180°

As can be seen from Table 1, the examples according to the invention demonstrate the following features:
1) improved gas yield for a comparable amount of water used in each example, as well as a much lower expanded foam bulk density (see in particular example 3),
2) better demolding behavior (i.e. shorter demolding times, see in particular example 5),
   and
3) much better long-term properties (see in particular example 5).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polyurethane elastomers comprising the reaction product of
(A) a polyol formulation comprising
a) a polyol component comprising:
a1) at least one polyetherpolyol having an OH number of 20 to 112 and a functionality of 2, and which is obtained by alkoxylation with propylene oxide and/or ethylene oxide such that the polyetherpolyol contains mainly primary OH groups;
b) one or more chain extenders and/or cross-linking agents which have a molecular weight of 60 to 499 g/mol;
c) optionally, one or more blowing agents;
d) one or more amine catalysts;
e) a catalyst mixture comprising (1) at least one organic titanium compound, (2) at least one organic zinc compound, (3) optionally, one or more organic lithium carboxylate, and (4) optionally, one or, more organic bismuth carboxylate;
and
f) optionally, additives;
with
(B) a polyisocyanate component;
while maintaining an equivalent ratio of NCO groups in (B) the polyisocyanate component to the sum of hydrogen atoms in components a), b), c), d) and e) that can react with NCO groups of 0.8:1 to 1.2:1.

2. The polyurethane elastomers of claim 1, wherein a) said polyol component additionally comprises:
a2) one or more polyetherpolyols having an OH value of 20 to 112 and a functionality of >2 to 3.5, which is obtained by alkoxylation with propylene oxide and/or ethylene oxide such that the polyether polyols contain mainly primary OH groups.

3. The polyurethane elastomers of claim 1, wherein a) said polyol component additionally comprises a solids containing polyol which is selected from the group consisting of (i) graft copolymers of styrene/acrylonitrile in a base polyol, (ii) polyaddition polymers of diamines and diisocyanates and (iii) mixtures thereof.

4. The polyurethane elastomers of claim 1, wherein the equivalent ratio of NCO groups in (B) said polyisocyanate component to the sum of hydrogen atoms that can react with NCO groups in components a), b), c), d) and e) is from 0.95:1 to 1.15:1.

5. The polyurethane elastomers of claim 4, wherein the equivalent ratio is 0.98:1 to 1.05:1.

6. The polyurethane elastomers of claim 1, wherein e) said catalyst mixture is present in an amount of 0.001 to 10 wt. %, based on the 100% by weight of components a), b), c), d) and f).

7. The polyurethane elastomers of claim 6, wherein e) is present in an amount of from 0.01 to 1 wt. %, based on 100% by weight of components a), b), c) d) and f).

8. The polyurethane elastomers of claim 1, wherein (B) said polyisocyanate component comprises a prepolymer which comprises the reaction product of:
1) a polyisocyanate selected from the group consisting of 4,4′-diphenylmethane diisocyanate, 4,4′-diphenylmethane diisocyanate modified by carbodiimidization, and mxixtures thereof;
with
2) one or more polyetherpolyols having an OH number of 20 to 112;
and
3) one or more polyethylene glycols and/or polypropylene glycols having a molecular weight of 135 g/mol to 700 g/mol.

9. A process for preparing polyurethane elastomers comprising reacting:
(A) a polyol formulation comprising:
a) a polyol component comprising:
a1) at least one polyetherpolyol having an OH number of 20 to 112 and a functionality of 2, and which is obtained by alkoxylation with propylene oxide and/or ethylene oxide such that the polyetherpolyol contains mainly primary OH groups;
b) one or more chain extenders and/or cross-linking agents having molecular weights of 60 to 499 g/mol;
c) optionally, one or more blowing agents;
d) one or more amine catalysts;
e) a catalyst mixture comprising (1) at least one organic titanium compound, (2) at least one organic zinc compound, (3) optionally, one or more organic lithium carboxylate, and, (4) optionally, one or more organic bismuth carboxylate;
and
f) optionally, additives;
with
(B) a polyisocyanate component;
while maintaining an equivalent ratio of NCO groups in (B) the polyisocyanate component to the sum of hydrogen atoms in components a), b), c), d) and e) that can react with isocyanate groups of 0.8:1 to 1.2:1.

10. The process of claim 9, wherein a) said polyol component additionally comprises:
a2) one or more polyetherpolyols having an OH number of 20 to 112 and a functionality of greater than 2 to 3.5, and which are obtained by alkoxylation with propylene oxide and/or ethylene oxide such that the polyether polyols contain mainly primary OH groups.

11. The process of claim 9, wherein a) said polyol component additionally comprises a solids containing polyol which is selected from the group consisting of (i) graft copolymers of styrene and/or acrylonitrile in a base polyol, (ii) polyaddition polymers of diamines and diisocyanates and (iii) mixtures thereof.

12. The process of claim 9, wherein the equivalent ratio of NCO groups in (B) said polyisocyanate component to the sum of hydrogen atoms that can react with NCO groups in components a), b), c), d) and e) is from 0.95:1 to 1.15:1.

13. The process of claim 12, wherein the equivalent ratio is from 0.98:1 to 1.05:1.

14. The process of claim 9, wherein e) said catalyst mixture is present in an amount of 0.001 to 10 wt. %, based on the 100% by weight of components a), b), c), d) and f).

15. The process of claim 14, wherein e) is present in an amount of from 0.01 to 1 wt. %, based on 100% by weight of components a), b), c) d) and f).

16. The process of claim 14, wherein (B) said polyisocyanate component comprises a prepolymer which comprises the reaction product of:
1) a polyisocyanate selected from the group consisting of 4,4′-diphenylmethane diisocyanate, 4,4′-diphenylmethane diisocyanate modified by carbodiimidization, and mxixtures thereof;
with
2) one or more polyetherpolyols having an OH number of 20 to 112;
and
3) one or more polyethylene glycols and/or polypropylene glycols having a molecular weight of 135 g/mol to 700 g/mol.

17. A process for making elastomeric molded parts having densities of 180 to 1100 kg/m³, wherein the elastomers comprise the reaction product of:
(A) a polyol formulation comprising:
a) a polyol component comprising:
a1) at least one polyetherpolyol having an OH number of 20 to 112 and a functionality of 2, and which is obtained by alkoxylation with propylene oxide and/or ethylene oxide such that the polyetherpolyol contains mainly primary OH groups;
b) one or more chain extenders and/or cross-linking agents having molecular weights of 60 to 499 g/mol;
c) optionally, one or more blowing agents;
d) one or more amine catalysts;
e) a catalyst mixture comprising (1) at least one organic titanium compound, (2) at least one organic zinc compound, (3) optionally, one or more organic lithium carboxylate, and, (4) optionally, one or more organic bismuth carboxylate;
and
f) optionally, additives;
with
(B) a polyisocyanate component;
while maintaining an equivalent ratio of NCO groups in (B) the polyisocyanate component to the sum of hydrogen atoms in components a), b), c), d) and e) that can react with isocyanate groups of 0.8:1 to 1.2:1.
